(19) United States
(12) Patent Application Publication
(10) Pub. No.: US 2012/0266634 A1
(43) Pub. Date: Oct. 25, 2012

(54) ENVIRONMENTAL CONTROL IN GLASS FIBER FORMING

(76) Inventors: Michael David Folk, Oregon, OH (US); Mark Beeman, Whitehouse, OH (US)

(21) Appl. No.: 13/090,337

(22) Filed: Apr. 20, 2011

(51) Int. Cl. C03B 37/01; C03B 37/12; B23P 23/00; C03B 37/083

(52) U.S. Cl. 65/464; 65/500; 29/401.1

(57) ABSTRACT

In a glass fiber forming station, bushing air is delivered to the veil from grills that encroach near the front and rear sides of the veil. Sealing material may at least partially seal the space around the bushing. The system may reduce the requirement for conditioned air, and may reduce the likelihood of dust entrainment in the veil. Pot sprays may be provided for additional cooling of the veil. In a method of retrofitting a glass fiber forming station, a station duct is attached to a main duct, and carries air from the main duct to a grill that extends near the veil, for example within 12 inches of the veil.

### BACKGROUND OF THE INVENTION

Glass fiber strands are used in many areas. For example, relatively long glass fiber strands may be embedded in various building materials such wall board, roofing components, or other building materials to lend strength. In another common use, chopped glass fiber strands may be mixed with molten polymer used in injection molding to produced fiber-filled plastic parts that are stronger than non-filled parts.

### BRIEF SUMMARY OF THE INVENTION

In a glass fiber forming station, bushing air is delivered to the glass veil from a grill that encroaches near the veil.

According to one aspect, a glass fiber forming station comprises a bushing having a plurality of nozzles through each of which a stream of molten glass descends to harden into a glass fiber. The glass streams and glass fibers are referred to as a veil, and the glass fibers in the veil re gathered into a common strand. The station further comprises a main duct carrying air to the forming station, and a grill coupled to the main duct. The grill encroaches nearer to the veil than does the main duct, and delivers air from the main duct to the veil. In some embodiments, the grill extends to within 12 inches of the veil. The glass fiber forming station may further comprise a station duct that delivers air from the main duct to the grill. In some embodiments, the main duct is a front main duct that carries air to a location in front of the veil and the grill is a front grill that delivers air to a front side of the veil, and the glass fiber forming station further comprises a rear main duct carrying air to a location behind the veil, and a rear grill that encroaches nearer to a back side of the veil than does the rear main duct, the rear grill delivering air from the rear main duct to the veil. The glass fiber forming station may further comprise a rear station duct that delivers air from the rear main duct to the rear grill. The rear grill may extend to within 12 inches of the veil. In some embodiments, the glass fiber forming station of further comprises a front pot spray nozzle delivering a cooling fluid to a front side of the veil. The front pot spray nozzle may be mounted to the grill. The glass fiber forming station may further comprise a rear pot spray nozzle delivering a cooling fluid to a rear side of the veil. In some embodiments, the glass fiber forming station further comprises a catwalk behind the veil, and a spray shield between the veil and the catwalk, wherein the rear pot spray nozzle is mounted to the spray shield. In some embodiments, the glass fiber forming station further comprises a bushing frame, and a sealing material between the grill and the bushing frame.

According to another aspect, a method of forming a glass strand comprises providing a bushing having a plurality of nozzles, and providing a supply of molten glass above the bushing, such that a stream of molten glass descends through each of the nozzles to harden into a glass fiber. The streams and fibers are referred to as a veil. The method further includes providing a supply of air in a main duct, delivering air to the veil from the main duct to the veil through a grill that is coupled to the main duct and extends nearer to the veil than does the main duct, to cool the streams of molten glass, and gathering the fibers into a common strand. The grill may extend within 12 inches of the veil. In some embodiments, the main duct is a front main duct that provides a supply of air in front of the veil and the grill is a front grill that delivers air to the front of the veil, and the method further includes providing a supply of air in a rear main duct behind the veil, and delivering air to the veil from the rear main duct to the veil through a rear grill that extends nearer to the veil than does the rear main duct, to cool the streams of molten glass. The rear grill may extend within 12 inches of the veil. In some embodiments, the method further includes delivering air from the front main duct to the front grill via a front station duct, and delivering air from the rear main duct to the rear grill via a rear station duct. The method may further include spraying a cooling fluid toward a front side of the veil. The method may further include spraying a cooling fluid toward a rear side of the veil.

According to another aspect, a method of retrofitting a glass fiber forming station comprises covering a portion of an opening in a main duct, and attaching a station duct to the main duct. The station duct is of a smaller cross section than the main duct, and the station duct is configured to deliver air from the main duct to a glass veil via a grill that extends nearer to the veil than does the main duct. The grill may extend within 12 inches of the veil. In some embodiments, the main duct is a front main duct, the station duct is a front station duct, and the grill is a front grill, and the method further comprises covering a portion of an opening in a rear main duct, and attaching a rear station duct to the rear main duct, the rear station duct being of a smaller cross section than the rear main duct, and the rear station duct configured to deliver air from the rear main duct to a glass veil via a rear grill that extends nearer to the veil than does the rear main duct. The rear grill may extend within 12 inches of the veil. The method may further include mounting a rear pot spray nozzle to the rear grill or to a spray shield positioned between the veil and a catwalk behind the veil. In some embodiment, the method further includes mounting a pot spray nozzle to the grill, the pot spray being configured to deliver a cooling fluid to the veil

### BRIEF DESCRIPTION OF THE DRAWINGS

FIG. 1 illustrates a simplified schematic front view of a glass fiber forming room.

FIG. 2 shows a simplified schematic side view of one forming station within a glass fiber forming room.

FIG. 3 shows a side view of a forming station in accordance with embodiments of the invention.

FIG. 4 illustrates an oblique view of a grill in accordance with embodiments of the invention.

FIG. 5 shows a portion of FIG. 3 in more detail.

FIG. 6 illustrates a portion of a glass fiber forming station in accordance with other embodiments of the invention.

### DETAILED DESCRIPTION OF THE INVENTION

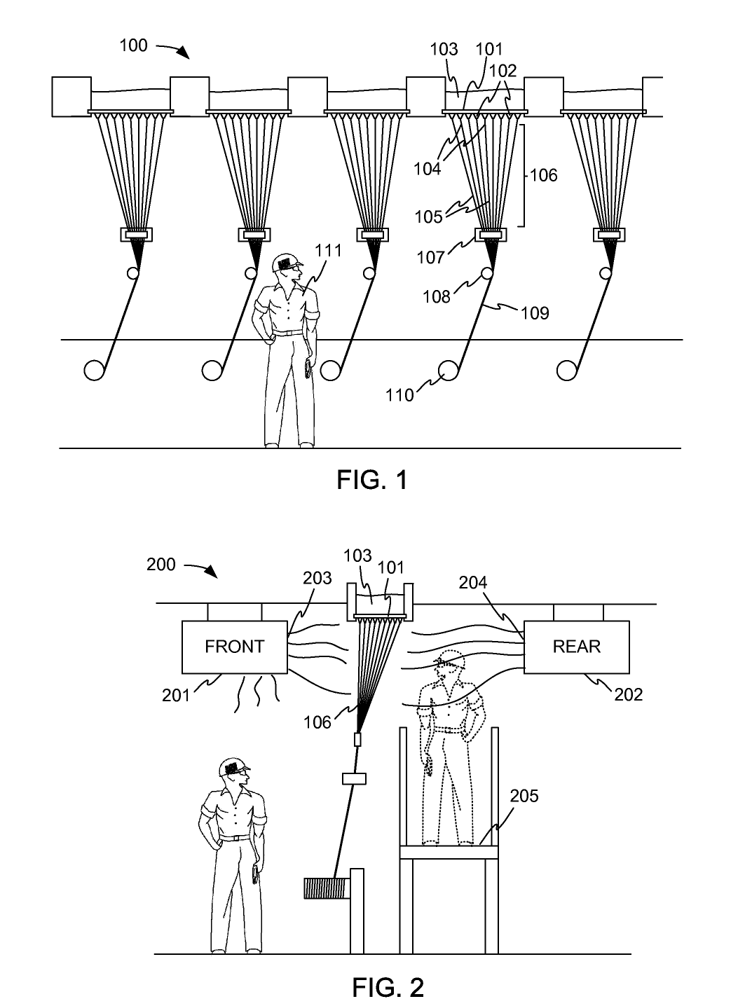

Glass fiber strands may be produced in forming rooms comprising a number of forming stations. FIG. 1 illustrates a simplified schematic front view of a glass fiber forming room 100. Forming room 100 includes five forming stations, although more or fewer forming stations may be present. Each forming station includes a bushing 101 having a plurality of nozzles or “tips” 102. Molten glass 103 is supplied to the bushings 101, and descends through the bushing nozzles 102 to form streams of molten glass 104. (The delivery of molten glass 103 to the bushings is highly simplified in FIG. 1). Molten glass streams 104 cool and harden to form glass fibers 105. The molten glass streams 104 and resulting glass fibers 105 may be collectively referred to as a “veil” 106. The veil may pass through an applicator 107, which applies sizing or other chemistry that promotes binding of the glass fibers. A gathering shoe 108 collects the fibers 105 into a common strand 109, which may in turn be wound on a spool 110, if continuous strands are to be produced. Alternatively, strands from multiple forming stations could be directed to a chopper that produces chopped fiber. An operator 111 may be present in the forming room to monitor and maintain the forming process.

The forming stations may be operated at very high speeds. For example, each forming station may produce strand 109 at the rate of hundreds or thousands of feet per minute. The flow of molten glass 103 through nozzles 102 is balanced with the speed of production so that the glass fibers 105 are attenuated to the desired diameter while avoiding the breakage of any stream 104 or fiber 105 if possible. Also, veil 106 must be cooled sufficiently that sizing or other chemistry can be applied at applicator 107 without degrading the function of the applied chemistry. In addition, the forming room must be kept at a temperature that is tolerable to operator 111.

Given the high initial temperature of molten glass 103 and the speed of production, large amounts of thermal energy are continually delivered to forming room 100 during production, and must be removed from forming room 100 to achieve sufficient product cooling and operator comfort. Historically, large amounts of chilled air have been supplied generally to the forming stations and the entire forming room.

FIG. 2 shows a simplified schematic side view of one forming station 200 of forming room 100. In the system of FIG. 2, front and rear main ducts 201 and 202 include front and rear main grills 203 and 204 which emit chilled air. Each of main ducts 201 and 202 may be, for example, a plenum or trunk duct that passes multiple forming stations, may be a protrusion from such a supply duct, or may otherwise be a source of conditioned air. Front main grill 203 may be as far as 24 inches or more from veil 206. Rear main grill 204 may be as far as 50 inches or more from veil 206, in part to accommodate catwalk 205 that enables operator access to bushing 101 and other system components. Chilling and transporting the large volumes of air delivered by front and rear main grills 203 and 204 may require significant energy resources.

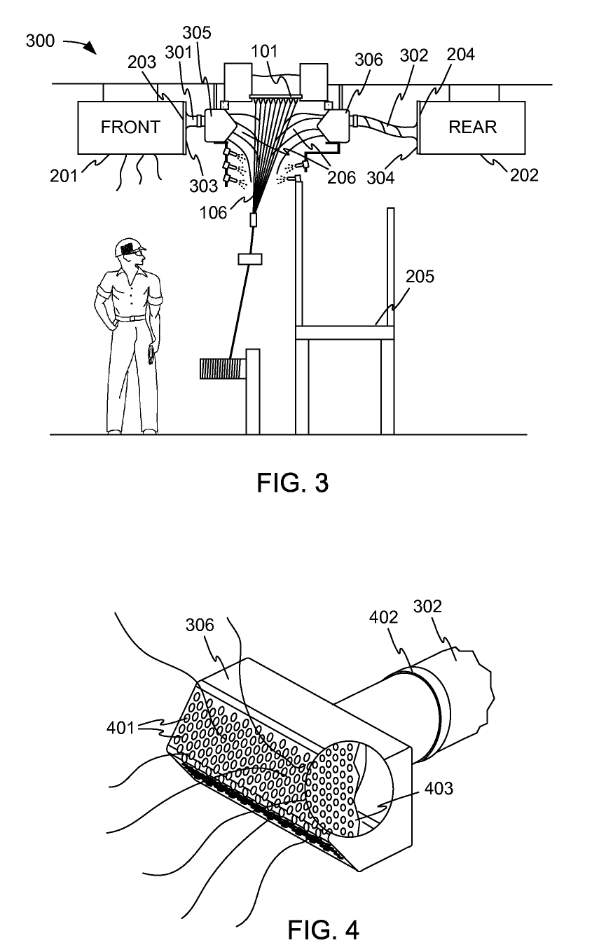

FIG. 3 shows a side view of a forming station 300 in accordance with embodiments of the invention. In this embodiment, front and rear main ducts 201 and 202 have been fitted with front station duct 301 and rear station duct 302. Front and rear station ducts 301 and 302 may be made, for example, of 6-inch diameter or another suitable size flexible ducting, and fitted to front and rear main ducts 201 and 202 by covering portions of front and rear main grills 203 and 204 with panels 303 and 304, which are cut out to interface with front and rear station ducts 301 and 302. Other arrangements are possible. For example, multiple smaller-diameter station ducts could be used in parallel at the front, rear, or both of the forming station.

Front and rear station ducts 301 and 302 deliver air from front and rear main ducts 201 and 202 to front and rear grills 305 and 306. Front and rear grills 305 and 306 in turn deliver the air 206 (which may be referred to as “bushing air”) to veil 106. Front and rear grills 305 and 306 may be of any suitable profile, including the profile shown in FIG. 3.

FIG. 4 shows exemplary rear grill 306 in more detail. Rear grill 306 may define a plurality of openings 401 through which air is delivered. Rear grill 306 could be made, for example, of sheet metal with a punched hole pattern forming openings 401. In other embodiments, rear grill 306 could comprise a wire screen formed over an appropriate enclosure, or could be fabricated in any other suitable manner. Front grill 305 could be identical to rear grill 306, or could be of a different shape, could be fabricated of different materials than rear grill 306, or could include other differences. A clamp 402 may secure rear station duct 302 to rear grill 306. Other attachment methods are possible. Various baffles or diffusers may optionally be used behind or within grill 306 to provide for even airflow from openings 401. For example, one or more perforated plates 403 could be used within grill 306, although other techniques and arrangements are possible.

Provision may be made for temporarily moving rear station duct 302 and rear grill 306 to allow access to bushing 101 from catwalk 205, for example for servicing or replacement of bushing 101. Other components may be present, but are omitted from the figures for clarity. For example, bushing 101 may be electrically heated, and a transformer may be mounted near bushing 101 to deliver electric power having the correct characteristics for heating bushing 101.

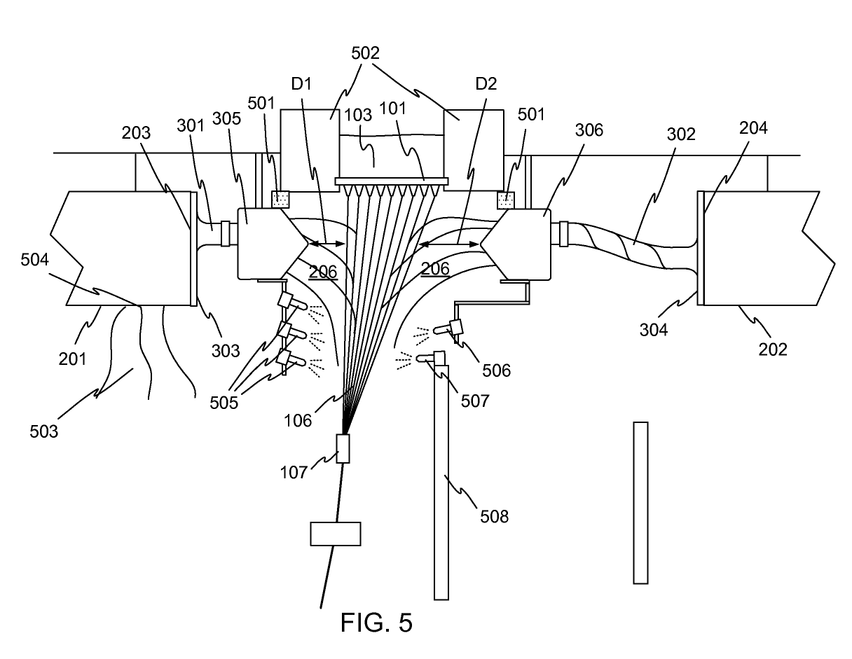

FIG. 5 shows a portion of FIG. 3 in more detail. As illustrated in FIG. 5, veil 106 entrains air as veil 106 moves rapidly downward. Part of the function of the environmental control system is to provide air from front and rear grills 305 and 306 in sufficient quantities to replace, with cool clean air, the air entrained and pulled downward by veil 106. In some embodiments, a slight surplus of air may be provided.

Front and rear grills 305 and 306 encroach near veil 106, extending to within distances D1 and D2 of veil 106. Distances D1 and D2, which may be the same or may differ, are smaller than the distances previously described between veil 106 and front and rear main grills 203 and 204 of main ducts 201 and 202. For example, in some embodiments, front grill 305 may extend to within 18 inches, to within 15 inches, to within 12 inches, to within 9 inches, or to within 6 inches of veil 106. Similarly, rear grill 306 may extend to within 18 inches, to within 15 inches, to within 12 inches, to within 9 inches, or to within 6 inches of veil 106. Because front and rear grills 305 and 306 extend much closer to veil 106 than do main ducts 201 and 202, less air may be lost to the surrounding environment than was lost from main grills 203 and 204, and consequently less air flow may be needed from grills 305 and 306 to replenish air entrained by veil 106 than was needed from main grills 203 and 204. This reduced requirement for conditioned air may result in cost savings, as less energy is consumed in conditioning the air. The proximity of the grills to the veil also reduces the opportunities for particulates in the forming area to be entrained in the air, and thus may reduce occurrence of breakage of the glass streams. Preferably, conditioned air is supplied in quantities sufficient to replenish the entrained air without flooding the surrounding area with turbulent air flows.

The reduced air flow from grills 305 and 306 may also result in a more gentle delivery of air to veil 106, with little turbulence. Accordingly, there may be a reduced tendency for dust and other particulates to be taken up in the moving air and entrained in veil 106. As a further measure for reducing the likelihood of dust entrainment, sealing material 501 may be placed between front and rear grills 305 and 306 and the structure 502 holding bushing 101. (Structure 502 is highly simplified in FIG. 5. An actual installation may include a bushing block, which is in turn affixed to a forehearth holding molten glass 103. The details may vary between installations.) Sealing material 501 is preferably made of a material that can withstand the elevated temperatures involved, for example, binderless glass fiber insulation, available from Johns Manville Corporation of Denver, Colo., USA. Other suitable materials could also be used. Preferably, sealing material 501 is compliant, to accommodate any irregularities in the surfaces of grills 305 and 306 or structure 502, and to accommodate small motions between the various components, due to mechanical vibration, thermal effects, or the like.

The reduced air flow afforded by a system in accordance with embodiments of the invention may affect the overall energy balance of the forming room in that less conditioned air is supplied to the room. To counter any detrimental effect on the comfort of operator, an increased amount of chilled “operator air” 503 may be provided via a grill 504 on the bottom of main duct 201.

Additional flexibility in cooling of veil 106 may be provided by one or more pot spray nozzles 505, 506, 507. Each pot spray nozzle present may deliver a cooling fluid, for example water, directly to veil 106 to further cool the fibers before the fibers reach applicator 107. (Plumbing used to provide the cooling fluid to the nozzles has been omitted from FIG. 5 for clarity.) The fluid provided by the pot spray nozzles may also lubricate the fibers in veil 106, improving later processing. The positioning of front and rear grills 306 and 306 near veil 106 provides further flexibility in the positioning of pot spray nozzles. For example, pot spray nozzles 505 are mounted to front grill 305. Pot spray nozzles 505 could also be mounted to front station duct 301, or another convenient location. Example pot spray nozzle 506 is mounted to rear grill 306, but could also be mounted to rear station duct 302 or another convenient location.

In some embodiments, a spray shield 508 resides between veil 106 and catwalk 205, to prevent at least some overspray from any pot spray nozzles 505 from reaching catwalk 205. The top of spray shield 508 provides another convenient location for the mounting of a pot spray nozzle such as pot spray nozzle 507.

A forming station in accordance with embodiments of the invention may be especially suitable for the use of pot spray nozzles, as the directed and relatively contained supply of bushing air 206 may tend to prevent upward travel of spray from the pot spray nozzles. Accumulation of mineral deposits on bushing 101 may thus be minimized, which may in turn improve the reliability of the production process.

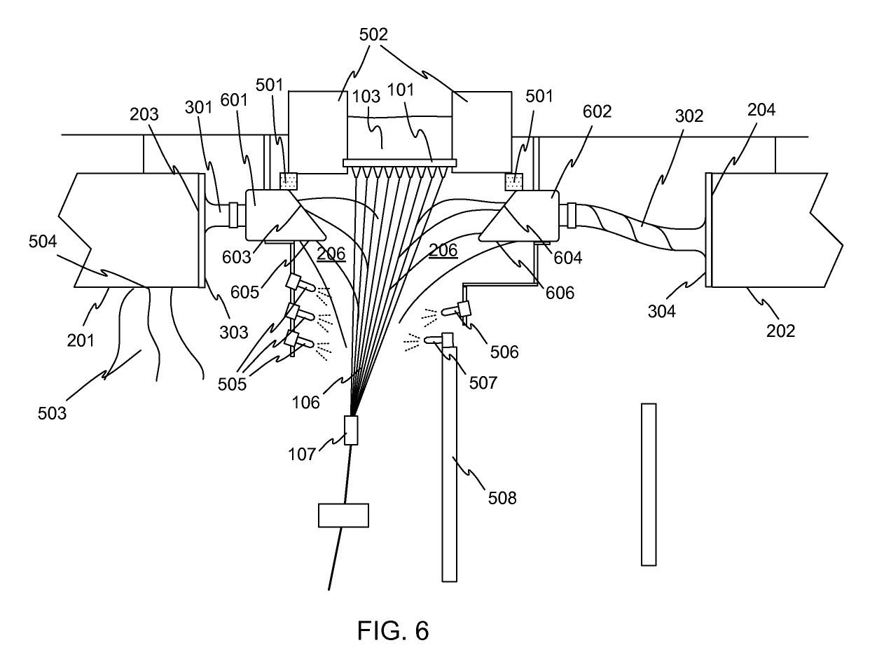

FIG. 6 illustrates a portion of a glass fiber forming station in accordance with other embodiments of the invention. The forming station of FIG. 6 differs from the forming station of FIG. 5 mainly in the shape of front and rear grills 601 and 602. Wedge-shaped grills 601 and 602 may achieve a different balance than grills 501 and 502 in the proportion of bushing air 206 directed generally upward toward bushing 101, and the proportion directed downward. Grills 601 and 602 may be constructed in any suitable way, including the constructions described above in relation to rear grill 502 shown in FIG. 4. Angled surfaces 603 and 604 and lower surfaces 605 and 606 may include openings allowing the flow of air from grills 601 and 602.

As described thus far, systems in accordance with embodiments of the invention may be especially suitable for retrofitting existing forming stations for improved performance. For example, in an existing forming station that includes front and rear main ducts 201 and 202 spaced large distances from veil 106, station ducts such as front and rear station ducts 301 and 302 may be added, with appropriate grills such as front and rear grills 305 and 306, to deliver bushing air 206 from grills located much closer to veil 106 than in the original installation. For example, grills such as grills 305 and 306 may extend to within 18 inches, to within 15 inches, to within 12 inches, to within 9 inches, or to within 6 inches of veil 106. Panels such as panels 303 and 304 may cover parts of existing grills, and assist in making the connection to station ducts 301 and 302. Pot spray nozzles may be added, and may be mounted, for example, to the grills or other convenient mounting points.

In other embodiments, for example in a newly-constructed forming station, appropriate grills may be positioned proximate veil 106 without requiring all of the components described above. For example, the reduced bushing air requirements afforded by the positioning of grills near veil 106 may enable a reduction in the size of supply ducts such as front and rear main ducts 201 and 202. Either or both of these ducts would then be positioned more closely to veil 106, and appropriate grills may be integrated into the main ducts, without the need for separate station ducts. Other arrangements of components are also possible, within the scope of the appended claims.

### Example

The effectiveness of embodiments of the invention is illustrated by data from one example experimental installation. It was observed that the veil entrained air at the rate of about 450 cubic feet per minute (cfm). The prior, unmodified environmental control system provided air from a front grill spaced about two feet from the veil, and from a rear grill spaced about four feet from the veil. For each station, conditioned air was supplied at the rate of about 1800 cfm, and at a temperature of about 52° F. The utility cost of conditioning this volume of chilled air is significant. After installation of a system in accordance with embodiments of the invention, bushing air was supplied from front and rear grills that extended to within 12 inches of the veil. The total flow rate was reduce to about 600 cfm, to provide an excess of bushing air over the amount entrained by the veil. The reduced requirement for conditioned air results in a significant savings in utility costs, while still providing reliable operation of the forming station. Additional cooling of the veil is provided by pot sprays as needed, at low utility cost. In addition, the partial sealing of the space above the veil and the surplus of bushing air over the entrained air volume provides a continuous downward flow that tends to keep dust from the surrounding environment from being entrained in the veil, and also tends to keep droplets of moisture from the pot sprays from drifting upward to contact the bushing.

The invention has now been described in detail for the purposes of clarity and understanding. However, those skilled in the art will appreciate that certain changes and modifications may be practiced within the scope of the appended claims.

What is claimed is:

1. A glass fiber forming station, comprising:
a bushing having a plurality of nozzles through each of which a stream of molten glass descends to harden into a glass fiber, the glass streams and glass fibers being referred to as a veil, the glass fibers in the veil being gathered into a common strand;
a main duct carrying air to the forming station; and
a grill coupled to the main duct, wherein the grill encroaches nearer to the veil than does the main duct, the grill delivering air from the main duct to the veil.

2. The glass fiber forming station of claim 1, wherein the grill extends to within 12 inches of the veil.

3. The glass fiber forming station of claim 1, further comprising a station duct that delivers air from the main duct to the grill.

4. The glass fiber forming station of claim 1, wherein the main duct is a front main duct that carries air to a location in front of the veil and the grill is a front grill that delivers air to a front side of the veil, the glass fiber forming station further comprising:
a rear main duct carrying air to a location behind the veil; and
a rear grill that encroaches nearer to a back side of the veil than does the rear main duct, the rear grill delivering air from the rear main duct to the veil.

5. The glass fiber forming station of claim 4, further comprising a rear station duct that delivers air from the rear main duct to the rear grill.

6. The glass fiber forming station of claim 4, wherein the rear grill extends to within 12 inches of the veil.

7. The glass fiber forming station of claim 1, further comprising a front pot spray nozzle delivering a cooling fluid to a front side of the veil.

8. The glass fiber forming station of claim 7, wherein the front pot spray nozzle is mounted to the grill.

9. The glass fiber forming station of claim 1, further comprising a rear pot spray nozzle delivering a cooling fluid to a rear side of the veil.

10. The glass fiber forming station of claim 9, further comprising:
a catwalk behind the veil; and
a spray shield between the veil and the catwalk;
wherein the rear pot spray nozzle is mounted to the spray shield.

11. The glass fiber forming station of claim 1, further comprising:
a bushing frame; and
a sealing material between the grill and the bushing frame.

12. A method of forming a glass strand, the method comprising:
providing a bushing having a plurality of nozzles;
providing a supply of molten glass above the bushing, such that a stream of molten glass descends through each of the nozzles to harden into a glass fiber, the streams and fibers being referred to as a veil;
providing a supply of air in a main duct;
delivering air to the veil from the main duct to the veil through a grill that is coupled to the main duct and extends nearer to the veil than does the main duct, to cool the streams of molten glass; and
gathering the fibers into a common strand.

13. The method of claim 12, wherein the grill extends within 12 inches of the veil.

14. The method of claim 12, wherein the main duct is a front main duct that provides a supply of air in front of the veil and the grill is a front grill that delivers air to the front of the veil, the method further comprising:
providing a supply of air in a rear main duct behind the veil; and
delivering air to the veil from the rear main duct to the veil through a rear grill that extends nearer to the veil than does the rear main duct, to cool the streams of molten glass.

15. The method of claim 14, wherein the rear grill extends within 12 inches of the veil.

16. The method of claim 14, further comprising:
delivering air from the front main duct to the front grill via a front station duct; and
delivering air from the rear main duct to the rear grill via a rear station duct.

17. The method of claim 12, further comprising:
spraying a cooling fluid toward a front side of the veil.

18. The method of claim 12, further comprising:
spraying a cooling fluid toward a rear side of the veil.

19. A method of retrofitting a glass fiber forming station, the method comprising:
covering a portion of an opening in a main duct; and
attaching a station duct to the main duct, the station duct being of a smaller cross section than the main duct, and the station duct configured to deliver air from the main duct to a glass veil via a grill that extends nearer to the veil than does the main duct.

20. The method of claim 19, wherein the grill extends within 12 inches of the veil.

21. The method of claim 19, wherein the main duct is a front main duct, the station duct is a front station duct, and the grill is a front grill, the method further comprising:
covering a portion of an opening in a rear main duct; and
attaching a rear station duct to the rear main duct, the rear station duct being of a smaller cross section than the rear main duct, and the rear station duct configured to deliver air from the rear main duct to a glass veil via a rear grill that extends nearer to the veil than does the rear main duct.

22. The method of claim 21, wherein the rear grill extends within 12 inches of the veil.

23. The method of claim 21, further comprising:
mounting a rear pot spray nozzle to the rear grill or to a spray shield positioned between the veil and a catwalk behind the veil.

24. The method of claim 19, further comprising:
mounting a pot spray nozzle to the grill, the pot spray being configured to deliver a cooling fluid to the veil.
